(19) United States
(12) Patent Application Publication
(10) Pub. No.: US 2019/0134658 A1
(43) Pub. Date: May 9, 2019

(54) OSCILLATING SPRINKLER WITH ROTATABLE LEGS

(71) Applicant: Vincent Cella, Medford, NJ (US)

(72) Inventor: Vincent Cella, Medford, NJ (US)

(21) Appl. No.: 16/145,718

(22) Filed: Sep. 28, 2018

Related U.S. Application Data
(60) Provisional application No. 62/565,214, filed on Sep. 29, 2017.

(51) Int. Cl. B05B 15/68; B05B 3/14; B05B 15/622; B05B 15/625

(52) U.S. Cl. CPC B05B 15/68; B05B 15/625; B05B 15/622; B05B 3/14

(57) ABSTRACT

An oscillating sprinkler has two base rails which are parallel to each other. The base rails are interconnected by a bridge support and the sprinkler's water drive housing. Two pairs of elongated legs are rotatably mounted to the base rails. The legs can be aligned and positioned parallel and adjacent to, along the sides of the sprinkler to allow it to be used directly on the ground surface. The sprinkler's legs can be rotated down 90° so that they are perpendicular to the base rails and, since the distal ends of the legs are sharp and spike-like, they can be driven into the ground in order to set the sprinkler at any desired height. This permits watering at higher elevations. The legs can also be adjusted and positioned at a variety of configurations for watering at different angles.

### RELATED APPLICATION

This application claims the benefit of provisional application No. 62/565,214, filed on Sep. 29, 2017.

### BACKGROUND OF THE INVENTION

Oscillating sprinklers have long been used to successfully hydrate lawns and gardens. While these sprinklers are effective in watering selected areas, they must be positioned flat on the ground and, as a result, the areas covered by the sprinkler are largely restricted. Watering is also limited at higher locations or at locations where watering is necessary, but which are at an angle to the ground.

### SUMMARY OF THE INVENTION

The present invention greatly expands the capability and versatility of oscillating sprinklers by providing a unique, rotatable leg design never contemplated by common oscillating sprinklers. The invention comprises two base rails which are parallel to each other, each base rail extending the length of the sprinkler. The base rails are interconnected by a bridge support and the sprinkler's water drive housing. Two pairs of elongated legs are rotatably mounted to the base rails. The legs of the sprinkler can be aligned and positioned parallel and adjacent to, along the sides of the sprinkler to allow it to be used directly on the ground surface. The sprinkler's legs can also be rotated down 90° so that they are perpendicular to the base rails and, since the distal ends of the legs are sharp and spike-like, they can be driven into the ground in order to set the sprinkler at any desired height above the ground. This permits watering at higher elevations. The legs can also be adjusted and positioned at a variety of configurations for watering at different angles.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a top, isometric view of the oscillating sprinkler of the present invention with its legs aligned and positioned along the sides of the sprinkler for watering when the sprinkler is placed directly on the ground surface.

FIG. 2 is a top view of the oscillating sprinkler of the present invention with its legs aligned and positioned along the sides of the sprinkler for watering when the sprinkler is placed directly on the ground surface.

FIG. 3 is an elevation view of the oscillating sprinkler of the present invention with its legs aligned and positioned along the sides of the sprinkler for watering when the sprinkler is placed directly on the ground surface.

FIG. 4 is an isometric view of the oscillating sprinkler of the present invention with its legs fully rotated down 90° from the base rails of the sprinkler.

FIG. 5 is an elevation view of the oscillating sprinkler of the present invention with its legs fully rotated down 90° from the body of the sprinkler.

FIG. 6 is a side isometric view of the oscillating sprinkler of the present invention with its legs rotated to permit the sprinkler body to operate at an angled position.

### DETAILED DESCRIPTION OF THE INVENTION

Oscillating sprinkler 1 comprises base rails 2 and 4, each extending the length of the sprinkler. Base rail bridge support 6 and sprinkler housing 8 which contains the sprinkler water drive mechanism, extend between and connect base rails 2 and 4. Water inlet 10 extends from housing 8 and water supply tube 12 is located between support 6 and housing 8, as is common in the art.

A first pair of elongated legs 14 is rotatably mounted at 16 and 18 to base rails 2 and 4 at one end of each of the base rails. A second pair of elongated legs 20 is rotatably mounted at 22 and 24 to base rails 2 and 4 at the opposite end of each of the base rails. Legs 14 and 20 have sharp, spike like distal ends 15, 17, 19, and 21.

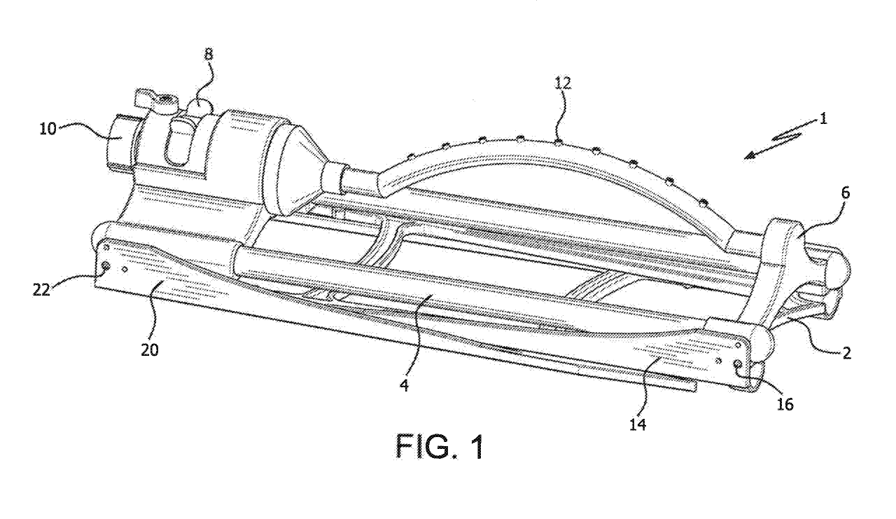

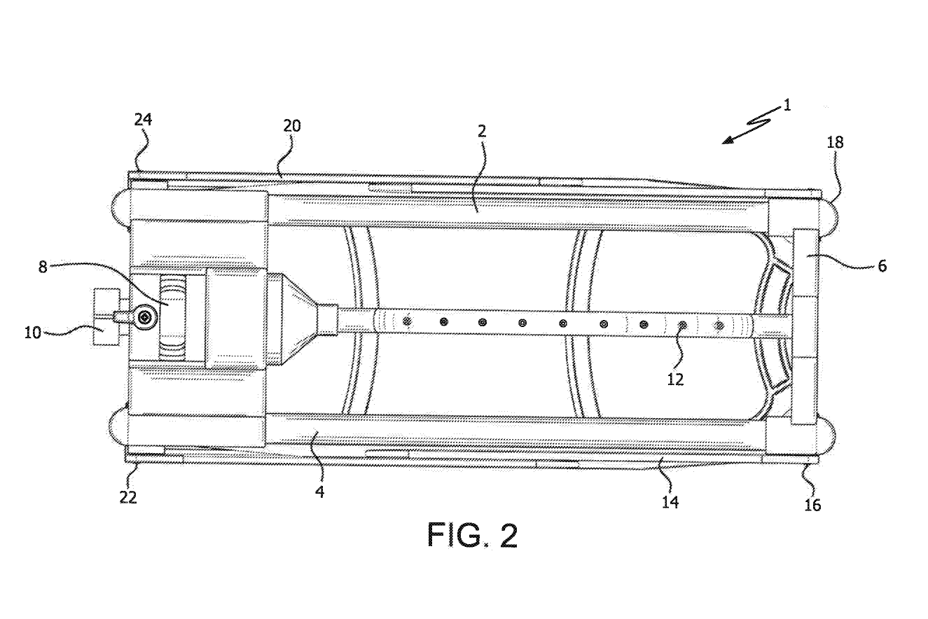

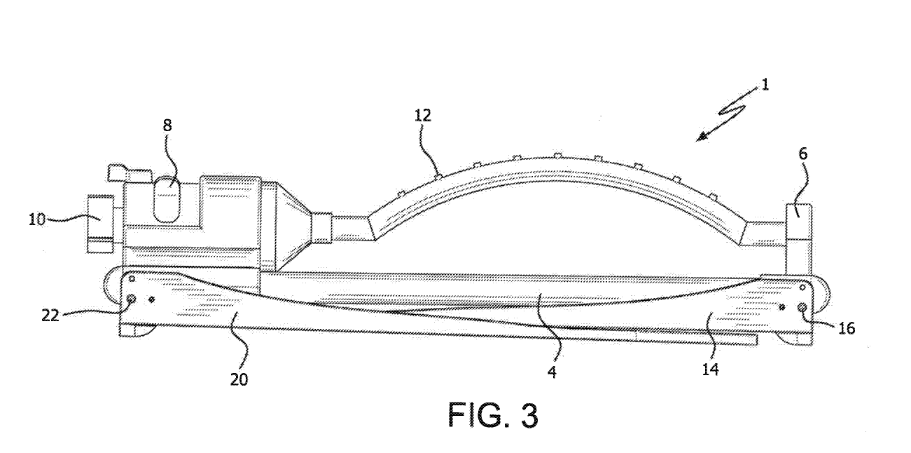

FIGS. 1-3 illustrate sprinkler 1 in a first position, with legs 14 and 20 aligned parallel with and adjacent to base rails 2 and 4. In this position, with legs 14 and 20 along the sides of base rails 2 and 4, sprinkler 1 can be placed directly on the ground and watering is accomplished in the manner in Which ordinary oscillating sprinklers are used.

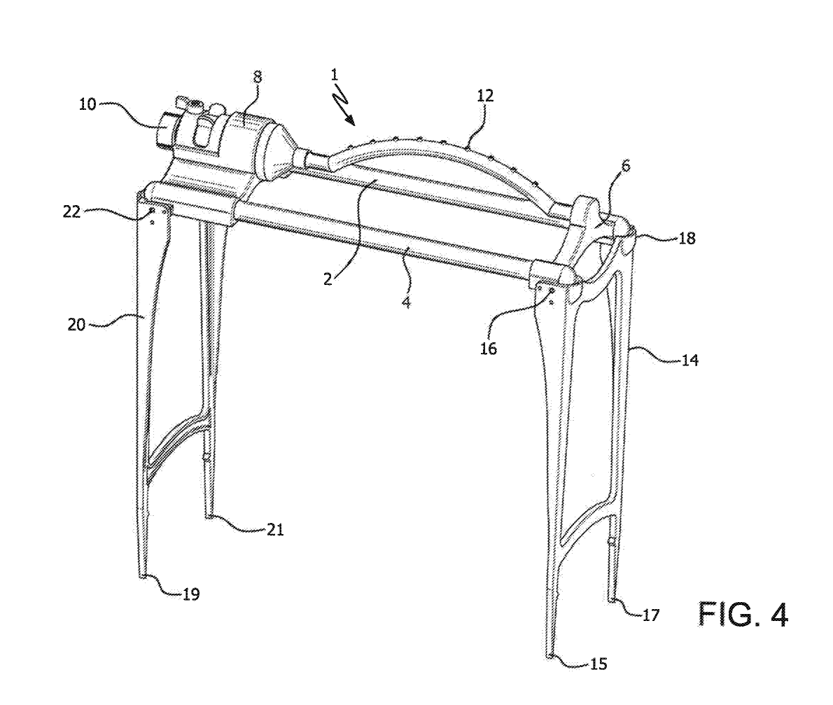

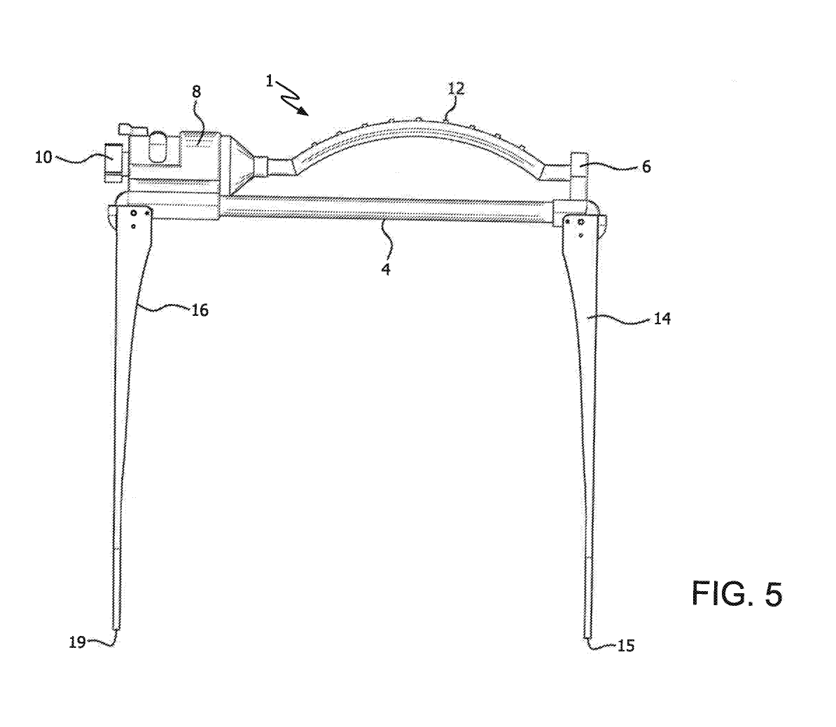

However, in a second position, shown in FIGS. 4 and 5 and novel to the invention, legs 14 and 20 are rotated down 90° from base rails 2 and 4 so that they are perpendicular to the base rails. In this position, sharp distal ends 15, 17, 19, and 21 permit legs 14 and 20 to be driven into the ground in order to set sprinkler 1 at any desired height above the ground, thus allowing watering at various elevations.

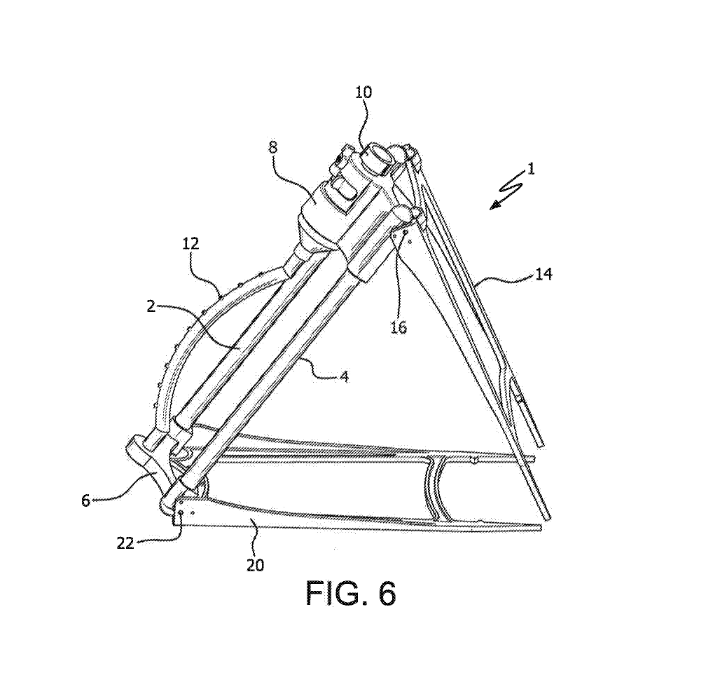

Sprinkler 1 can also be set at a variety of angular positions in order to water at different angles. Towards this end, legs 14 and 20 are adjustably rotated to any number of acute angles in relation to base rails 2 and 4. One such position is illustrated in FIG. 6, wherein leg 14 is rotated to an acute angle which allows it to be placed flat on the ground and leg 20 is acutely angled to support base rails 2 and 4 in an angled, third disclosed position.

Certain novel features and components of this invention are disclosed in detail in order to make the invention clear in at least one form thereof However, it is to be clearly understood that the invention as disclosed is not necessarily limited to the exact form and details as disclosed, since it is apparent that various modifications and changes may be made without departing the spirit of the invention.

1. An oscillating sprinkler comprising:
two base rails parallel to each other, each base rail extending the length of the sprinkler;
a base rail bridge support extending between and connecting the two base rails at a first end of each of the base rails;
a sprinkler water drive housing extending between and connecting the two base rails at a second end of each of the base rails, the housing having a water inlet; and
two pairs of elongated legs, one pair of legs being rotatably mounted to the base rails at the first ends of each of the base rails and a second pair of elongated legs being rotatably mounted to the base rails at the second end of each of the base rails, whereby in a first position the two pairs of elongated legs are aligned parallel with and adjacent to the base rails and in a second position the elongated legs are extended down, perpendicular to the base rails, the elongated legs being configured to be rotated from the first position to the second position.

2. The oscillating sprinkler as in claim 1 whereby in a third position the elongated legs are set at acute angles in relation to the base rails, the legs being configured to be rotated from the first position to the third position.

3. The oscillating sprinkler as in claim 1 wherein the elongated legs have sharp, spike-like distal. ends.

4. An oscillating sprinkler comprising:
two base rails parallel to each other, each base rail extending the length of the sprinkler;
a base rail support bridge extending between and connecting the two base rails at a first end of each of the base rails;
a sprinkler water drive housing extending between and connecting the two base rails at a second end of each of the base rails, the housing having a water inlet; and
two pairs of elongated legs, one pair of legs being rotatably mounted to the base rails at the first ends of each base rails and a second pair of elongated legs being rotatably mounted to the base rails at the second end of each base rail, the legs being rotatably adjustable so as to extend at an angle of 90° in relation to the base rails and at acute angles in relation to the base rails.

5. The oscillating sprinkler as in claim 4 wherein the elongated legs have sharp, spike-like distal ends.
